(19) United States
(12) Patent Application Publication
(10) Pub. No.: US 2004/0116095 A1
(43) Pub. Date: Jun. 17, 2004

(54) High dynamic range radio frequency mixer

(75) Inventor: David H. Shen, Saratoga, CA (US)

Correspondence Address: DAVID H. SHEN, IRF Semiconductor, Inc., 6 RESULTS WAY, CUPERTINO, CA, 95014, US

(73) Assignee: IRF SEMICONDUCTOR, INC.

(21) Appl. No.: 10/729,341

(22) Filed: Dec. 5, 2003

Related U.S. Application Data
(60) Provisional application No. 60/431,967, filed on Dec. 10, 2002.

(51) Int. Cl. H04B 1/26

(52) U.S. Cl. 455/323; 455/326

(57) ABSTRACT

The high dynamic range mixer is disclosed which enables wideband frequency translation of radio frequency signals and particularly suited for radio with zero-IF or low-IF receiver architectures, as the dynamic range requirements on the mixers in these radios are particularly severe.

THIS APPLICATION IS BASED ON THE PROVISIONAL APPLICATION No. 60/431,967 FILED ON Dec. 10, 2002

### BACKGROUND

1. Technical Field of Invention

The present invention relates to a method of implementing a high dynamic range mixer enabling wideband frequency translation of radio frequency signals. This invention is particularly suited for radio with zero-IF or low-IF receiver architectures, as the dynamic range requirements on the mixers in these radios are particularly severe.

2. Background of the Invention and Discussion of Prior Art

At the present time, the vast majority of RF communications receivers are of the superheterodyne type. This type of receiver uses one or more IF (intermediate frequency) stages for filtering and amplifying signals at a fixed frequency within an IF chain. This radio architecture has the advantage that fixed filters may be used in the LO chain. In order for the receiver to be useable over multiple bands, its typical architecture is as the dual-band receiver shown in FIG. 1. An RF signal arriving at an antenna 11 passes through a band-select RF filter 13, an LNA (low noise amplifier), 15, and into an image filter, 17, which produce a band-limited RF signal. This band-limited RF signal then enters a first mixer 19, which translates the RF signal down to an intermediate frequency by mixing it with the signal produced by the first LO (local oscillator) 21. The undesired mixer products in the IF signal are rejected by an IF filter, 23. The filtered IF signal then enters an IF amplifier stage, 25, after which the outputs feeds into the second mixer 27 which translates it down to yet another intermediate frequency by mixing it with the signal produced by a second LO, 28. The signal is then sent to the baseband processing. Tuning to a particular channel within the band-limited RF signal is accomplished by varying the frequency of each LO, 21 and 28.

In order to reduce size, power consumption, and cost, it would be advantageous to integrate the electronic components of radio receivers and reduce the number of filters and mixers. The superheterodyne design, however, requires high quality, narrowband IF bandpass filters that are typically implemented off-chip. These filtering components impose a lower limit to the size, materials cost, assembly cost, and power consumption of receivers built using the superheterodyne design. Moreover, the necessity for mixer and local oscillator circuits operating at high frequencies contributes greatly to the power consumption and general complexity of the superheterodyne receiver. In particular, the high-frequency analog mixers require a large amount of power to maintain linear operation. Although many variations of the superheterodyne design exist, they all share the limitations of the particular design just described.

A second receiver design is the direct-conversion, or zero-IF, receiver shown in FIG. 2. An antenna 37 couples a RF signal through a first bandpass RF filter, 39, into a LNA, 41. The signal then proceeds through a second RF filter 43, yielding a band-limited RF signal, which then enters a mixer, 45, and mixes with an LO frequency produced by an LO, 47. Up to this point, the direct-conversion receiver design is essentially the same as the previous receiver design.

Unlike the previous designs, however, the LO frequency is set to the carrier frequency of the RF channel of interest. The resulting mixer product is a zero-frequency IF signal—a modulated signal at baseband frequency. The mixer output, 47, is coupled into a lowpass analog filter 49 before proceeding into baseband information signal for use by the remainder of the communications system. In either case, tuning is accomplished by varying the frequency of LO, 47, thereby converting different RF channels to zero-frequency IF signals.

Because the direct-conversion receiver design produces a zero-frequency IF signal, its filter requirements are greatly simplified—no external IF filter components are needed since the zero-IF signal is an audio frequency signal that can be filtered by a low-quality lowpass filter. This allows the receiver to be integrated in a standard silicon process from mixer 45 onwards, making the direct-conversion receiver design potentially attractive for portable applications.

The direct-conversion design, however, has several problems, one of which is that the mixer dynamic range can limit the performance of the system. Another integrated receiver architecture uses a low intermediate frequency (low IF) instead of zero IF. However, the performance of the architecture is similarly limited by the design of the mixer.

Presently, the most commonly used mixer design is based on a single-balanced mixer in FIG. 3. The mixer can be made a double-balanced mixer with fully differential inputs with no loss of generality. However, for simplicity of description, this description will focus on the single-balanced mixer. In the mixer of FIG. 3, an RF input signal 51 is converted to a current 53 by a transistor 55. The current 53 is modulated by differential local oscillator signals 57 and 59 acting upon transistors 61 and 63. The modulated current 65 and 67 is converted to output voltages 69 and 71 by load devices 73 and 75. The dynamic range of the mixer is set by noise on the low end and mixer linearity on the high end. The noise of the mixer is determined by the noise in devices 55, 61, 63, 73 and 75. Conversion gain in the mixer reduces the contribution of noise from the load devices 73 and 75 as well as noise of other circuitry connected to the output of the mixer. The linearity of the mixer is determined by the linearity of the active devices 55, 61, and 63 along with the amount of output swing at node 69 and 71.

The prior art also includes passive mixers that have high linearity, but also high noise. This high noise results from the fact that passive mixers have attenuation that cause an amplification of noise at the output of the mixer.

### OBJECTS AND ADVANTAGES OF THE INVENTION

Accordingly, it is a primary object of the present invention to provide novel mixer design, which has increased dynamic range performance compared to the prior art.

### SUMMARY OF THE INVENTION

The present invention achieves the above objects and advantages by providing a new method for mixer implementation that achieves high dynamic range by combining an active mixer with an operational amplifier to achieve high linearity, yet maintain conversion gain to achieve low noise.

### DESCRIPTION OF THE PREFERRED EMBODIMENT

FIG. 4 is a schematic diagram of a high dynamic range mixer constructed in accordance with the principles of the present invention. In the mixer of FIG. 4, an RF input signal 77 is converted to a current 79 by a transistor 81. The current 79 is modulated by differential local oscillator signals 83 and 85 driving transistors 87 and 89. The modulated currents 91 and 93 are connected to current source loads 95 and 97, which provide a DC bias to maintain the DC common mode voltage at voltage nodes 99 and 101. A differential operational amplifier 103 is used to convert the modulated currents 91 and 93 to a voltage at nodes 105 and 107. Feedback load devices 109 and 111 can be resistive to provide gain or a combination of resistors and capacitors to create a filtered output at nodes 105 and 107. Since the operational amplifier 103 has high gain and is in a feedback configuration, the output at nodes 105 and 107 is highly linear, thus improving the linearity of the mixer. In addition, the conversion gain of the mixer allows the devices 81, 87, and 89 to be the dominant sources of noise in the circuit, and reduces contributions of noise from devices connected to the output of the mixer.

Those skilled in the art will recognize that the mixer can easily be made double-balanced, that the transistors can be bipolar, MOS, or any other transistor type, and that the source degeneration resistors can be added to the transistors with no loss of generality. These and other modifications to the preferred embodiment are intended to be within the scope of the invention.

### DESCRIPTION OF DRAWINGS

FIG. 1 is a block diagram of a dual-band superheterodyne receiver considered as prior art.

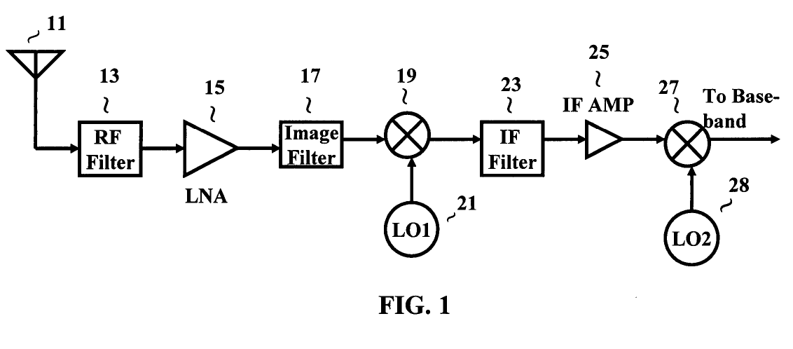

FIG. 2 is a block diagram of a direct-conversion receiver considered as prior art.

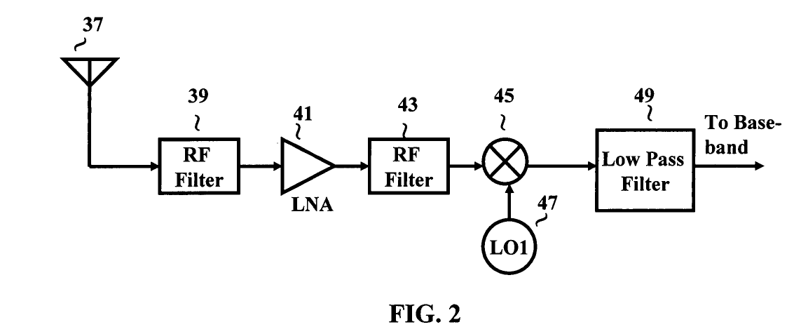

FIG. 3 is a schematic of the prior art single-balanced mixer.

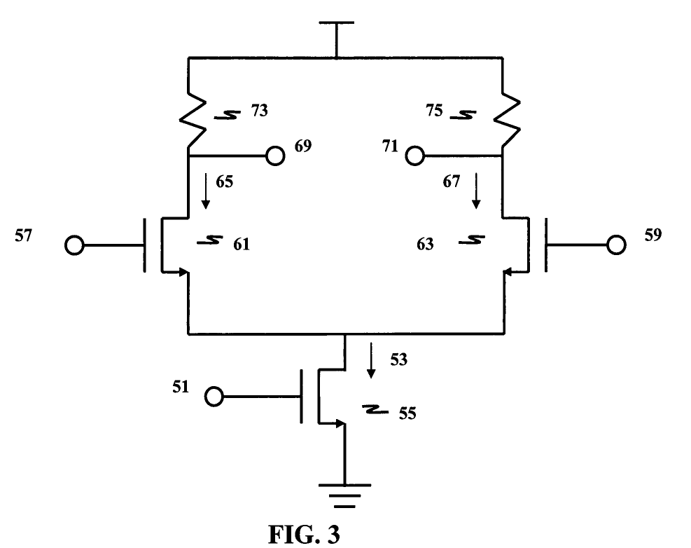

FIG. 4 is a schematic of the preferred embodiment of the invention.

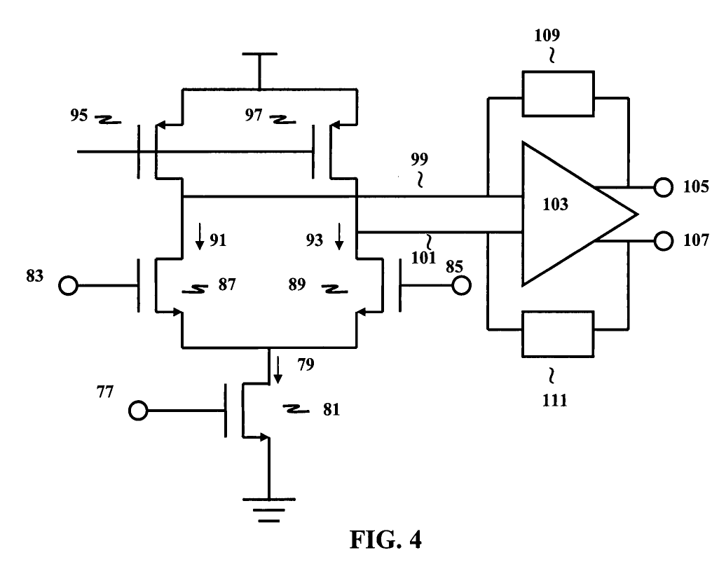

1. A method for a high dynamic range mixer comprising
a first transistor whose gate is connected to an RF input and whose drain is connected to the sources of
a second and third transistor whose gates are connected to a differential local oscillator inputs and whose drains are each connected to
one input of a differential operational amplifier and each connected to
a fourth and fifth transistor each acting as a current source. Each output of the differential operational amplifier is connected to an input of the differential amplifier through
a first and second feedback load device.

2. The method of claim 1 wherein the RF input is differential and the mixer is a double-balanced mixer.

3. The method of claim 1 wherein the first transistor source is connected to a series degeneration resistor.

4. The method of claim 1 wherein the second and third transistor sources are connected to series degeneration resistors.

5. The method of claim 1 wherein the second and third transistor sources are connected series inductors.

6. The method of claim 1 wherein the first and second feedback load devices are resistors.

7. The method of claim 1 wherein the first and second feedback load devices are a parallel network of resistors and capacitors.

8. The method of claim 1 wherein the transistors are bipolar.

9. The method of claim 1 wherein the transistors are MOS.

10. The method of claim 1 wherein the transistors are of any known transistor type.

11. The method of claim 1 wherein the operational amplifier has a common-mode feedback circuit connected to it.

12. The method of claim 1 wherein the current source transistors are replaced by resistors.
